(19) United States
(12) Patent Application Publication
(10) Pub. No.: US 2008/0163375 A1
(43) Pub. Date: Jul. 3, 2008

(54) Embedding and patching integrity information in a program file having relocatable file sections

(76) Inventors: Uday R. Savagaonkar, Beaverton, OR (US); David M. Durham, Beaverton, OR (US)

Correspondence Address: INTEL/BLAKELY, 1279 OAKMEAD PARKWAY, SUNNYVALE, CA, 94085-4040, US

(21) Appl. No.: 11/647,896

(22) Filed: Dec. 28, 2006

(51) Int. Cl. H04L 9/32

(52) U.S. Cl. 726/26

(57) ABSTRACT

Methods and apparatuses enable embedding integrity manifest information into a program in volatile memory. Instead of having fixed integrity manifest information that cannot be changed after compilation, a file of a format supporting relocatable file sections can store the integrity manifest information for a program. The integrity manifest information can be modified in-line, while the file is loaded in volatile memory, and the information stored to disk for later re-use. The program and its associated file can include a modifiable integrity manifest indicator that provides the location and size of the integrity manifest, and can be changed as appropriate. The indicator can be passed to a service processor to indicate the integrity manifest to the service processor.

### FIELD

Embodiments of the invention relate to digital security, and more particularly to adding security information inline in a program in memory.

### BACKGROUND

The proliferation of viruses and worms has been an increasing security issue for computing systems. Some viruses and worms are capable of breaching the kernel boundary, which can allow the virus/worm to tamper with critical kernel components responsible for monitoring the security of the system. As used herein, critical kernel components may be referred to as “agents” or “programs.” The agent can be treated as a digitally signed document when monitoring the agent for integrity (e.g., such as through techniques developed by INTEL CORPORATION of Santa Clara, Calif., specifically Host Agent Measurement (HAM) or System Integrity Services (SIS)). The agents are monitored for integrity by an adjunct service partition (e.g., INTEL AMT (ACTIVE MANAGEMENT TECHNOLOGY)). The adjunct service partition monitors the agent integrity via an agent integrity manifest containing a digital signature and information about relocation fix-ups for the agent. The adjunct service partition inverts the relocation fix-ups and computes the digital signature to compare against an expected signature (e.g., a stored signature) to determine the integrity of the agent.

However, providing the agent integrity manifest to the service partition in a scalable fashion is non-trivial. Previous methods for providing the information via remote out-of-band connections, or through direct memory access (DMA) are burdensome on the adjunct partition when the number of monitored agents increases because integrity manifest information has previously been available only through a separate file. Additionally, as a practical matter, integrity information was previously inaccessible to a kernel component, given that previous methods (e.g., driver signing) either make the integrity manifest information inaccessible to the agent, or require the agent to read the information from a separate file. Integrity manifest information has also traditionally been loaded into memory separately from the agent itself, requiring additional processes to ensure that the integrity information is in memory. Thus, the integrity manifest information was not previously available in a usable manner to be provided to the adjunct partition. Additionally, the memory space available for integrity manifest information was previously fixed once the agent was generated.

### BRIEF DESCRIPTION OF THE DRAWINGS

The following description includes discussion of various figures having illustrations given by way of example of implementations of embodiments of the invention. The drawings should be understood by way of example, and not by way of limitation.

FIG. 1 is a block diagram of an embodiment of a system with compile-time components that provide integrity information in a file.

FIG. 2 is a block diagram of an embodiment of a system with run-time components that provide integrity information in a file.

FIG. 3 is a block diagram of an embodiment of an agent source file with integrity manifest variables, and an ELF file generated from the agent source file.

FIG. 4 is a block diagram of an embodiment of an integrity information management module.

FIG. 5 is a flow diagram of an embodiment of a process for adding integrity information inline into a program in memory.

FIG. 6 is a flow diagram of an embodiment of a process for locating a section in a section header table.

FIG. 7 is a flow diagram of an embodiment of a process for locating a section in an ELF file.

FIG. 8 is a flow diagram of an embodiment of a process for adding contents to an ELF section.

FIG. 9 is a flow diagram of an embodiment of a process for locating a symbol in a symbol table.

FIG. 10 is a flow diagram of an embodiment of a process for locating a symbol in an ELF file.

FIG. 11 is a flow diagram of an embodiment of a process for modifying the value of a variable related to integrity information.

FIG. 12 is a flow diagram of an embodiment of a process for pointing a variable to an offset inside a section of an ELF file.

### DETAILED DESCRIPTION

As used herein, references to one or more “embodiments” are to be understood as describing a particular feature, structure, or characteristic included in at least one implementation of the invention. Phrases such as “in one embodiment” or “in an alternate embodiment” appearing herein describe various embodiments and implementations of the invention, and do not necessarily all refer to the same embodiment. However, they are also not necessarily mutually exclusive. Descriptions of certain details and implementations follow, with an overview description of embodiments of the invention, followed by a more detailed description with reference to the drawings.

A software agent written in a format that supports relocatable file sections can be generated to allow for adding programmatically accessible signed manifest information to the agent's object file. The agent includes one or more variables that indicate a location and size of the manifest. The agent object file is modified to add integrity manifest information to a read-only data section of the agent object file. Because the agent object file is of a format that supports relocatable sections, memory can be dynamically provisioned, and the manifest information can by dynamically changed, even when the agent is already loaded in memory. For purposes of example and simplicity in description, files compatible with the Executable and Linkable Format (ELF) will be described. The description with reference to ELF files should not be understood as limiting, rather as illustrative of any file format that supports relocatable file sections. Thus, ELF may be used in one embodiment, and other formats used in other embodiments.

The variable location and size information is modified in the agent object file to reflect the actual location and size of the integrity manifest in (volatile) memory. As used herein, unless otherwise indicated, “memory” refers to volatile memory, which is typically the main memory of a system. Non-volatile or persistent memory will be referred to as “storage” to avoid confusion in terminology. Non-volatile or persistent storage retains its values (and thus retains information stored thereon) even when power to the storage is interrupted for short or long periods. On initialization of the agent in memory, the agent can communicate the location and size of the agent integrity manifest to the service partition, also referred to as a service processor. With the agent integrity manifest in the read-only data section of the object file (e.g., the .rodata section), the operating system (OS) loader loads the integrity manifest into memory whenever the loadable kernel module (LKM) of the agent is loaded into memory. Thus, the integrity manifest information is made available, and is communicated to the service processor.

With the integrity manifest information in the read-only data section of the object file and the variable(s) in the agent source, the agent integrity manifest information is automatically loaded into memory with the loading of the agent, and can be communicated to the service processor. Thus, the agent integrity manifest information can be communicated to the service processor in a scalable fashion and made available in memory whenever the agent is loaded. Furthermore, the software agents can access their integrity information in a programmatic manner without relying on external files, and can provide the integrity information to third parties (e.g., a service processor) at runtime. Additionally, the agent can access and use the integrity information for self-verification. Furthermore, the location and size of the integrity manifest information is variable-controlled, which can be modified in the object file. Because ELF supports relocation of file sections, the integrity manifest information can be dynamically modified, updated, and/or added to inline, or while the agent is in memory. The developer does not need to reserve space in the source program for integrity information.

Note a distinction between ELF files and WINDOWS (of MICROSOFT CORPORATION of Redmond, Wash.) PE (Portable Executable) files. WINDOWS PE files have various format constraints. One method for embedding integrity manifest information into a WINDOWS PE file requires allocating large, initialized buffers in the source program, into which the integrity information is placed after the link phase. Integrity information embedded in such an approach is limited to not being larger than the pre-allocated buffer in the source program. The pre-allocation limitation prevents any modifications to the binary file (including patching) after addition of the integrity information, since such an addition could change the size of the integrity information. In contrast to embedding agent integrity manifest information in a WINDOWS PE file, placing the agent integrity manifest information in an ELF file allows the dynamic allocation of buffer sizes in the binary files. The source files could be patched in the field, and the integrity manifest information could still be embedded in the patched files. The pre-allocated buffer limits do not apply to the ELF file.

Basic mechanisms for locating and accessing section and symbol information in an ELF file are described in more detail below. Through the use of the basic mechanisms described below, the agent integrity manifest information can be loaded into system memory and communicated to the isolated service processor. As mentioned above, the adding of agent integrity manifest (AIM) information to an existing program can be accomplished through the use of an AIM indicator in the source program, modifying the variables in the object file, and providing run-time loading of the AIM.

In one embodiment, the AIM information indicator includes two special-purpose variables added to the source program. In one embodiment, the variables are declared as constant (const) variables, which are initialized to non-zero values. By initializing a constant variable to a non-zero value, the variables are added to the .rodata section of the resulting ELF object file by the compiler. Alternatively, the AIM information indicator could have a single value where upper and lower bits indicate the location and size of the AIM. The AIM information indicator could alternatively be a data structure/object.

The program source code is compiled/linked with the AIM information indicator (e.g., the special variables) that is added to the source code. The resulting ELF file generated from the compiling/linking will have space reserved in the .rodata section for AIM information indicator. With the ELF object file and the basic mechanisms described below, the system or host device on which the program executes computes the size of the signed manifest and generates the signed manifest itself. The value for the manifest size is stored by assigning the value to an associated variable. The agent integrity manifest itself is added to the .rodata section. The variable associated with the location of the manifest is also updated to point to the offset of the manifest in the .rodata section.

The run-time behavior of the program is to have the signed integrity manifest loaded into memory when the program is loaded. Because the signed integrity manifest has been added to the .rodata section of the program, the manifest is loaded to the memory when the program is loaded. The program code can then determine the size of the manifest through the manifest size variable, and the address of the manifest through the manifest location variable. The manifest is thus accessible to the program, and is not located in a separate file. The program may use the values of the variables to communicate the size and run-time virtual memory location of the manifest to the service processor.

In addition to enabling the program to communicate the integrity manifest information to the service processor, updating the integrity manifest is also possible through the mechanisms described herein. After a program has been released to customers, it may be necessary and/or desirable to patch or update the program. An update may include additional information, whereas a patch describes the differences between the current version of the program and the updated version of the program. Typically, customers apply patches to the executable programs on site.

However, patching the program changes the contents of the executable portions of the program, which may make the integrity manifest information embedded in the program outdated. According to the mechanisms described herein, when a patch is available for a program, the integrity manifest may be removed from the existing program, and the program patched, as per patching rules. A new integrity manifest is computed for the patched program, and the new integrity manifest is added back into the program by processing the ELF object file.

Note that the program patch may need to be signed before being applied and a new integrity manifest created. Alternately, the program vendor may create a signed manifest and ship it with the program patch. The patching tools can be modified to add the new integrity manifest into the program automatically with the patch, rather than having a system administrator perform the modification manually.

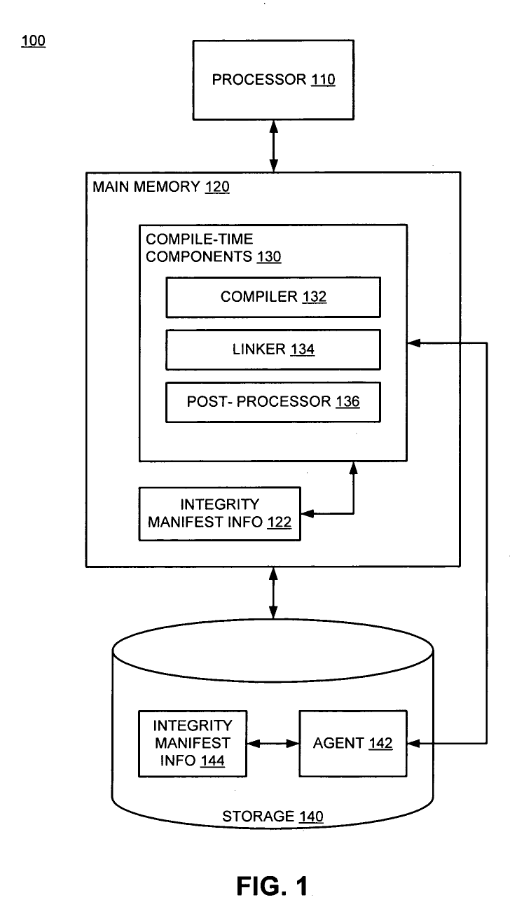

FIG. 1 is a block diagram of an embodiment of a system with compile-time components that provide integrity information in a file. System 100 includes processor 110, which provides computing capabilities and the ability to execute various operations. Processor 110 may include any type of microprocessor, central processing unit (CPU), processing core including multi-core devices, etc., which may be based on any processing architecture. In one embodiment, processor 110 represents separate physical processor chips that operate in conjunction. Processor 110 controls the overall operation of system 100, and may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Processor 110 is coupled to main memory 120, which provides temporary (volatile) storage for code or data to be executed/processed in system 100. As used herein, coupling refers to any type of connectivity, whether electrical, mechanical, and/or communicative. Coupling of one device to another may occur through other hardware. Software components can be coupled to each other or to hardware through function calls, or other invocations of a routine/subroutine. In one embodiment, processor 110 includes a memory controller hub (MCH, not shown), which may be integrated onto an integrated circuit of processor 110, or may exist external to processor 110. Main memory 120 may include one or more varieties of random access memory (RAM, e.g., static RAM (SRAM), dynamic RAM (DRAM) synchronous DRAM (SDRAM), etc.), or a combination of memory technologies.

Main memory 120 is coupled to storage 140, which represents any type of non-volatile storage, including, but not limited to conventional magnetic disks, optical disks (e.g., CD-ROM (compact disk-read-only memory), DVD (digital video/versatile disc)), semiconductor-based storage (e.g., Flash), etc. Storage 140 includes agent 142 and associated integrity manifest information 144 (described in more detail below). Agent 142 and its associated modules, as well as integrity manifest information 144, are loaded from storage 140 to main memory 120 to execute agent 142.

Main memory 120 is depicted with compile-time components 130, which can be used to generate agent 142, integrity manifest information 144, and/or other components. Note that although compile-time components are depicted in system 100 that has agent 142 stored on storage 140, it is not necessary to store the compiled code of agent 142 on the compiling system. That is, source code is not necessarily compiled/linked on the same system that will execute the compiled code, and frequently compiled code is intended for execution on another system. Thus, compile-time components 130 may generate agent code, which is then transferred from main memory 120 to a disk (e.g., a CD-ROM), intended to be sent to another system, or from main memory over a network link to another system, for execution of agent 142.

Compile-time components 130 may include compiler 132, linker 134, post-processor 136, and/or other components not depicted in FIG. 1. Compiler 132 compiles source code to generate objects, which linker 134 then assembles into an executable program. Agent 142 represents the compiled and linked executable program generated from agent source code (not shown). Compile-time components 130 may also include post-processor 136 to add integrity manifest information 144 into agent 142 object code (e.g., an ELF file). Post-processor 136 may also be used to add patch information to agent 142 and/or its integrity manifest information. Integrity manifest information 122 may be computed and then stored as integrity manifest information 144 on storage 140. In one embodiment, agent 142 is an unprocessed or raw agent, and when processed, integrity manifest information 144 may become part of agent 142.

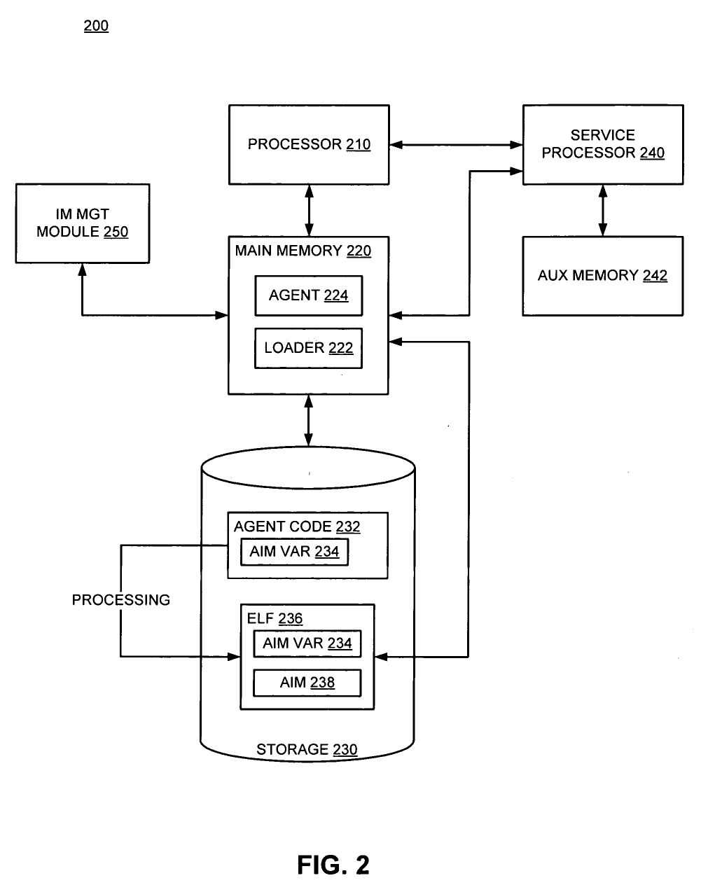

FIG. 2 is a block diagram of an embodiment of a system with run-time components that provide integrity information in a file. System 200 illustrates components of a system having run-time components associated with agent integrity manifest information for an agent or program. Processor 210 is a processing component of system 200, and represents an example of processor 110 of FIG. 1. Main memory 220 represents an example of main memory 120 of FIG. 1, and holds programs for execution.

In one embodiment, memory 220 includes loader 222, which represents a module that loads a program from storage 230 to memory 220. Loader 222 may perform relocation fix-ups on programs loaded into memory 220 based on relocation information provided for the programs. Storage 230 includes agent code 232, which may be a kernel component program as discussed above. Specifically, agent 232 represents an unprocessed or raw agent. Agent code 232 includes AIM (agent integrity manifest) variable (var) 234, which represents an AIM information indicator. The values of AIM variable 234 may be initialized, but not specifically set, which will occur during processing of the agent. AIM variable 234 may be one or more variable entries that provide values to indicate a size of the AIM, and a location of the AIM in volatile memory. In one embodiment, the size of the AIM is known prior to run-time. Alternative implementations may include receiving an AIM or an AIM patch while the agent is loaded in memory, and run-time information is provided to reflect the AIM size. The location of the AIM in volatile memory can be provided by loader 222 when agent 232 is loaded into memory 220.

Agent code 232 is processed (e.g., compiled) which may include processing by a post-processor, to generate an object file that has the agent and its AIM information (if any is present). Processing of agent code 232 generates ELF 236, which represents an object file. ELF 236 includes AIM variables 234, which may have actual values for one or more dynamic variables (e.g., AIM size). Additionally, ELF 236 includes AIM 238, assuming an AIM exists for agent code 232 at the time of processing agent code 232. If no AIM exists, agent code 232 can be processed without an AIM, which can be later embedded because of AIM variables 234 that allows for dynamic provisioning of memory resources for embedding the AIM. The processed ELF 236 is loaded into main memory 220.

ELF file 236 includes zero or more sections that contain information necessary or useful to load, run, and/or debug the program represented by agent code 232. Other information not necessary for running the program (e.g., author name) may also be included. AIM variables 234 can be passed by agent 224 (loaded in memory 220) to service processor 240, which may be a microprocessor in system 200, or a secure partition, thread, virtual machine, etc., of processor 210. Service processor 240 includes one or more software/firmware modules to provide integrity monitoring functions (e.g., verifying the information in the integrity manifest). Service processor 240 may include a memory or memory partition that is separate from main memory 220, as represented by auxiliary (aux) memory 242. In one embodiment, auxiliary memory 242 may be inaccessible by any component of system 200 except service processor 240. In one embodiment, auxiliary memory 242 is a trusted memory device or other secure storage, where agent image hashes, AIM check values, etc., may be stored.

Indicating AIM 238 to service processor 240, or making service processor 240 aware of AIM 238, enables service processor 240 to verify the integrity of agent 224. Although a complete explanation of AIM 238 is not provided herein, an overview of integrity manifests is provided below. AIM 238 describes the structure of an executable file as it would appear in memory. The AIM is derived from the code structure of the associated program, and thus should represent a unique identity for the program. If a check of AIM indicates a difference with a known good version accessible to the service processor, the service processor can determine that the program has been unexpectedly modified, and is thus insecure or a security risk. AIM 238 includes one or more integrity check values (ICVs), which represent agent signatures, or other signing to attest the validity of the AIM, e.g., a cryptographic hash of one or more fields of AIM 238. AIM 238 also includes ICVs indicating a check value for a section or portion of the associated agent program. Performing a check algorithm on the agent code in the main memory 220 should produce a determinable result (i.e., either the same result, or a result that varies in an expected way) as indicated in AIM 238.

In addition to measured segments, AIM 238 includes relocation fix-ups that enable proper, determinable measurement of the agent while in memory. Loader 222 provides the proper memory location of references to other dynamically loaded components to indicate the actual virtual address of the component in memory.

System 200 may also include integrity manifest (IM) management (mgt) module 250. IM management module 250 provides functionality related to inline adding of integrity manifest information for a program in memory. As used herein, inline refers to the fact that the integrity manifest information is placed directly in memory, and can be stored back out to disk or storage. Instead of needing to generate the information in conjunction with the executable and shipping the integrity manifest with the agent program, the integrity information can be added later. IM management module 250 can receive integrity manifest information, add it to the agent, and update necessary indicators/fields in the agent.

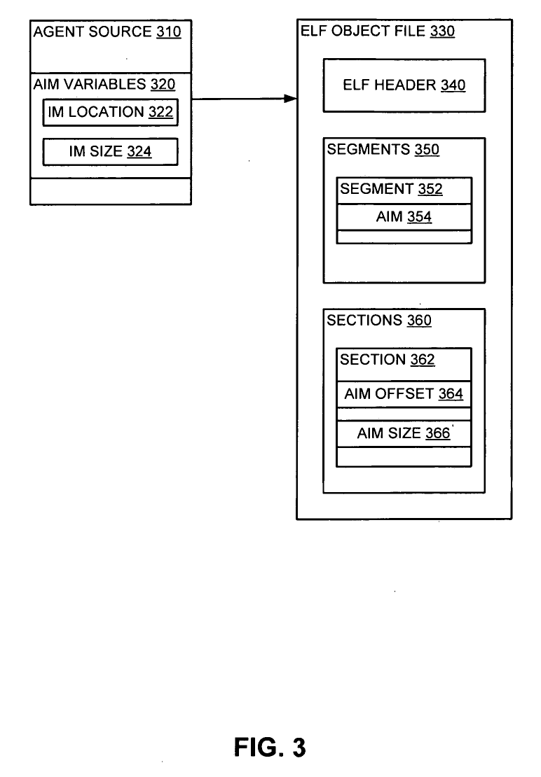

FIG. 3 is a block diagram of an embodiment of an agent source file with integrity manifest variables, and an ELF file generated from the agent source file. A compiler generates object files, which a linker combines into an executable. Generally a compiler processes source code to generate the object files. A post processor is an entity that performs processing on the generated object files instead of on the source code. Agent source file 310 can include agent integrity manifest (AIM) variables 320. Note that the AIM variables indicate the integrity manifest, but are not strictly required for the execution of the agent (except to the extent that presenting the integrity manifest is required for execution of the agent by the system in which the agent will execute). In one embodiment, agent source file 310 originally does not have AIM variables 320, and is modified to include them.

AIM variables 320 are integrity manifest indicators, and can be used to communicate integrity manifest information to the service processor. AIM variables 320 may include an integrity manifest (IM) location variable 322 and an integrity manifest size variable 324. The values of the AIM variables are modified when agent source file 310 is processed. IM location variable 322 indicates a location of the integrity manifest in ELF file 330. IM size variable 324 indicates a size of the integrity manifest.

ELF file 330 includes ELF header 340, which indicates the file type and the location of tables that indicate zero or more other sections associated with ELF file 330. Segments 350 include one or more segments that have related sections (e.g., text segment, data segment). In one embodiment, integrity manifest segment 352 is generated, and is the segment where AIM 354 is stored.

ELF file 330 may include zero or more sections 360, which may have executable code, data, dynamic linking information, debugging data, symbol tables, relocation information, comments, string tables, notes, etc. In one embodiment, section 362 includes integrity manifest information, such as AIM offset 364 and AIM size 366, which correspond to AIM variables 320. AIM offset 364 indicates an offset within segments 350 at which AIM 354 is located. AIM size 366 indicates the size of the AIM portion of the segment.

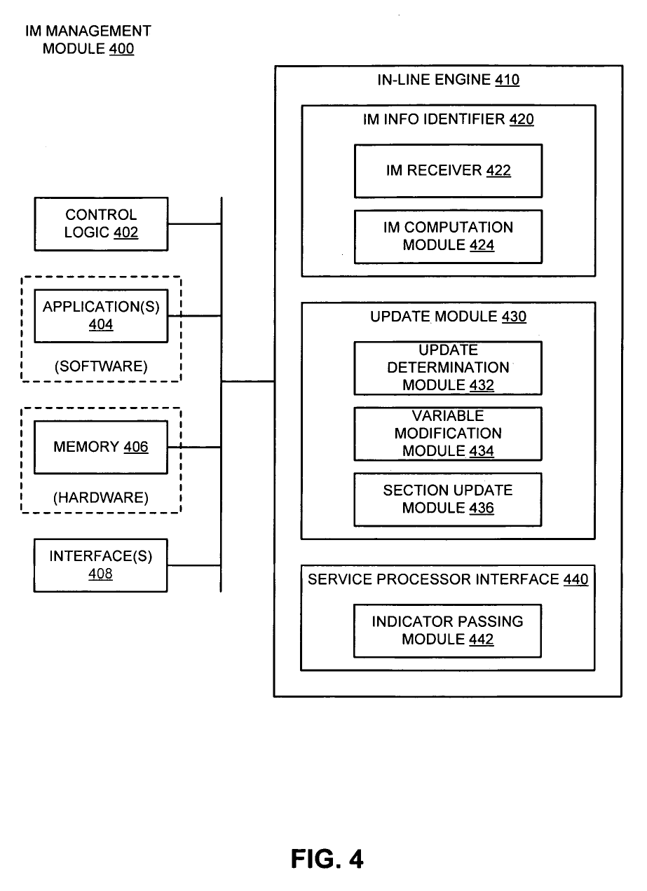

FIG. 4 is a block diagram of an embodiment of an integrity information management module. IM management module 400 includes control logic 402, which implements logical functional control to direct operation of IM management module 400, and/or hardware associated with directing operation of IM management module 400. Logic may be hardware logic circuits and/or software routines. In one embodiment, the logic may be instructions executing on a processor of a computing device. Thus, in a software implementation, logic 402 provides instructions for the control of operation of a processor that executes IM management module 400. In a hardware implementation, logic 402 represents circuitry that provides functional control (e.g., outputs on a signal line). Logic 402 may also refer to the operating instructions and circuitry that control, for example, an embedded processor in an implementation with software and hardware combined.

In one embodiment, in an implementation that is partially or wholly software, IM managment module 400 includes one or more applications 404, which represent code sequences and/or programs that provide instructions to control logic 402. Applications 404 may be code executing on a common processor that executes IM management module 400.

In one embodiment, IM management module 400 includes memory 406 and/or access to memory resource 406 for storing data and/or instructions. In a hardware implementation, a hardware circuit that represents IM management module 400 may include a memory device. In a software implementation, memory 406 can be understood to refer to the ability of a software module to store data in memory and access registers for the execution of code. Thus, memory 406 may include memory local to IM management module 400, as well as, or alternatively, including memory of a storage server on which IM management module 400 resides.

IM management module 400 also includes one or more interfaces 408, which represent access interfaces to/from (an input/output interface) IM management module 400 with regard to entities external to IM management module 400. In one embodiment, IM management module 400 is accessible as a component of a system that can be manipulated externally by a user through a user interface. Thus, interfaces 408 may include graphical user interfaces, keyboards, pointer devices, etc., in an implementation where IM management module 400 is accessible to human users. In an alternative embodiment, IM management module 400 executes “behind the scenes” to a human user, meaning the module performs its functions without being visible to the human user. However, even if not visible to a human user as a separate component, IM management module 400 can be accessible to external electronic components, or external software applications. Thus, in one embodiment, interfaces 408 include mechanisms through which external programs may access the module (e.g., drivers in a hardware implementation of IM management module 400, application program interfaces (APIs) in a software implementation, etc.).

IM management module 400 also includes in-line engine 410, which represents one or more functional components that enable IM management module 400 to provide management operations related to embedding integrity manifest information. The functions or features of the components include, or are provided by, one or more of IM information identifier 420, update module 430, and service processor interface 440. Each module may further include other modules to provide specific functionality. As used herein, a module refers to a routine, a subsystem, etc., whether implemented in hardware, software, or some combination. One or more modules can be implemented as hardware while other(s) are implemented in software.

Note that IM management module 400 may or may not be a single component. In one embodiment, IM management module 400 represents multiple modules or entities that work in conjunction to embed integrity manifest information and modify integrity manifest information of a program according to changes to the information. In one embodiment, IM management module 400 represents one or more sub-components of a security or platform management entity.

IM information identifier 420 enables in-line engine 410 to identify new/updated integrity manifest information to be embedded into a program or its associated elements (e.g., an ELF file). In one embodiment, the new integrity manifest information is received from an external source (e.g., as part of a program update). In one embodiment, IM information identifier 420 can request updates, or can query whether updates are available, or request a specifically known patch or update. In response to the request, integrity manifest information or integrity manifest patch information may be received. IM receiver 422 represents components that enable in-line engine 410 to interface with external entities and receive updated integrity manifest information. In one embodiment, a new integrity manifest is computed in the system that executes the program. IM computation module 424 enables in-line engine 410 to generate one or more elements of an integrity manifest in conjunction with a program and/or integrity manifest update.

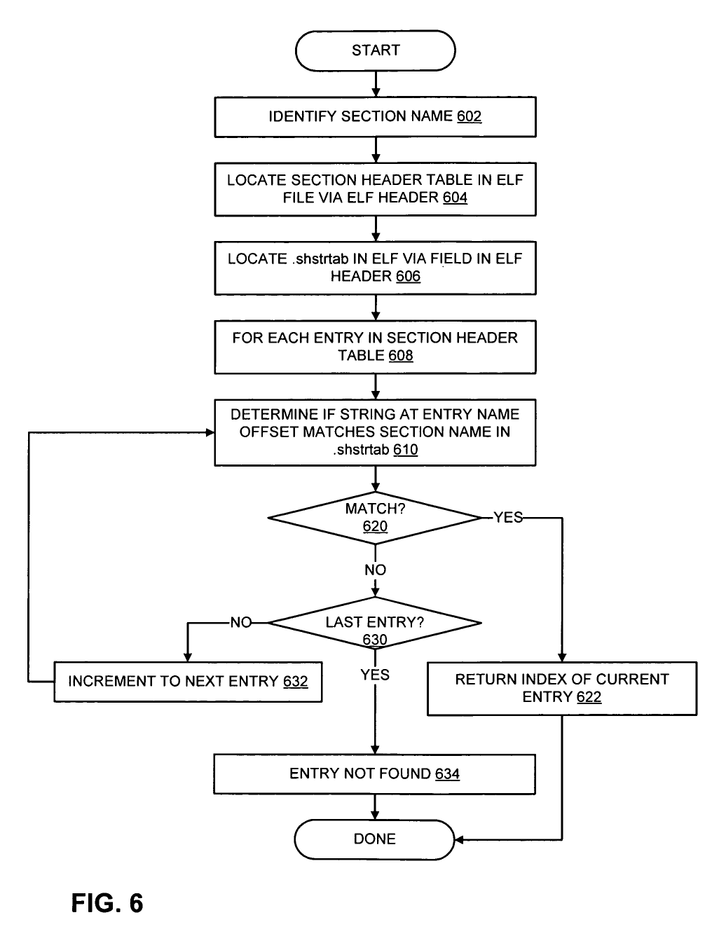

Update module 430 enables in-line engine 430 to store in-line or embed integrity manifest information in a program or in an object file associated with the updated program. Update module 430 also modifies variables in the object file. Thus, the updates to the program will generally change integrity manifest information, which in turn may necessitate updating information regarding the location and size of the integrity manifest. Update module 430 may invoke or execute the mechanisms described below in FIGS. 6-12. Update module 430 may work in conjunction with a patch executable that patches the updated program. In one embodiment, update module 430 includes update determination module 432 to determine whether or not to update information. For example, the size and/or location of an integrity manifest may remain the same, and the information need not be updated. Update module 430 includes variable modification module 434 to implement the modification of the value of variables (e.g., AIM location, AIM size) associated with the integrity manifest information. Update module 430 includes table update module 436 to change any information necessary in the various tables of an ELF file or other object file with relocatable sections. For example, modification of the integrity manifest may require changing the size of a section of the ELF file that includes the integrity manifest, which may necessitate changing the location of (relocating) other sections. The location changes may require updating the table indicating section location. Other tables for symbols and variables may also be changed, depending on the changes implemented to the integrity manifest and/or the program (e.g., new symbols are added).

Service processor interface 440 enables in-line engine 410 to interface with a service processor that requests integrity manifest information. Service processor interface 440 includes indicator passing module 442 that passes the variables that enable the service processor to locate and read the integrity manifest. Because the integrity manifest and the integrity manifest information are made available to the agent itself, the agent is able to provide the information to the service processor. Additionally, because the integrity manifest information is part of the agent object file, the integrity manifest information is loaded into volatile memory whenever the agent is loaded into volatile memory.

The descriptions herein of managers or modules, describe components that may include hardware, software, and/or a combination of these. In a case where a component to perform operations described herein includes software, the software data, instructions, and/or configuration may be provided via an article of manufacture by a machine/electronic device/hardware. An article of manufacture may include a machine readable medium having content to provide instructions, data, etc. The content may result in an electronic device as described herein, performing various operations or executions described. A machine readable medium includes any mechanism that provides (i.e., stores and/or transmits) information/content in a form accessible by a machine (e.g., computing device, electronic device, electronic system/subsystem, etc.). For example, a machine readable medium includes recordable/non-recordable media (e.g., read only memory (ROM), random access memory (RAM), magnetic disk storage media, optical storage media, flash memory devices, etc.). The machine readable medium may further include an electronic device having code loaded on a storage that may be executed when the electronic device is in operation. Thus, delivering an electronic device with such code may be understood as providing the article of manufacture with such content described herein. Furthermore, storing code on a database or other memory location and offering the code for download over a communication medium may be understood as providing the article of manufacture with such content described herein.

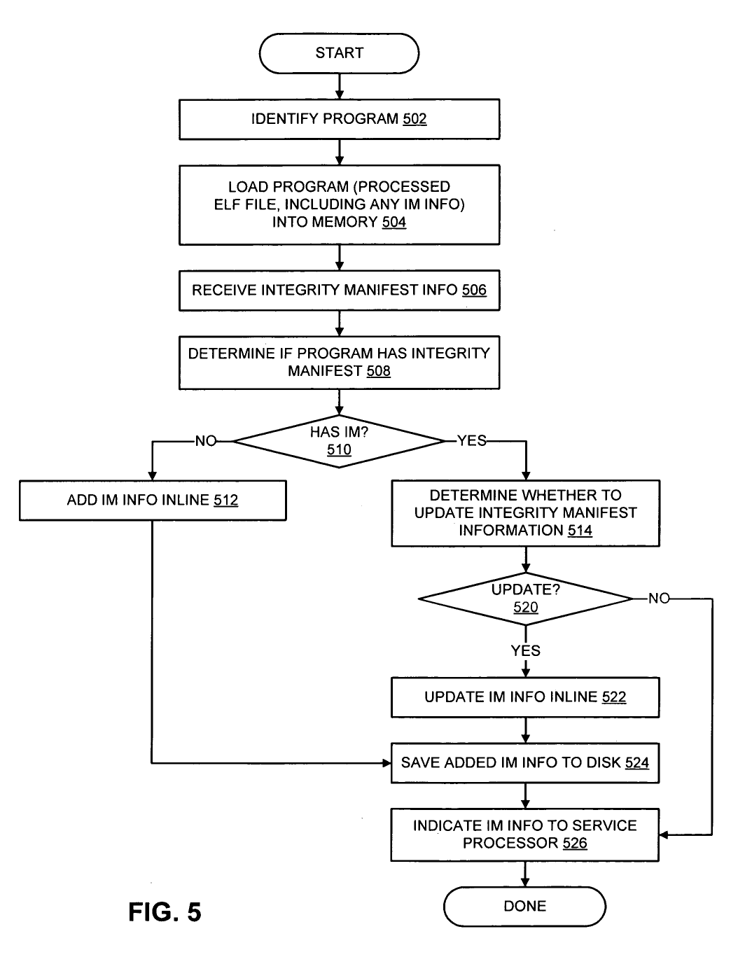

FIG. 5 is a flow diagram of an embodiment of a process for adding integrity information inline into a program in memory. A loader identifies a program to be loaded into memory, 502. The loader loads the identified program into memory (the processed object (ELF) file(s)), including any integrity manifest information embedded in the object file of the program, 504. An AIM management module receives integrity manifest information associated with the program, 506. The AIM management module determines if the program has an associated integrity manifest, 508.

If the program does not have an integrity manifest, 510, the AIM management module adds the integrity manifest information inline, including adjusting tables and variable values in the program, 512. If the program has an integrity manifest, 510, the AIM management module determines whether to update the existing integrity manifest information with the received information, 514. For example, the AIM management module may first verify the validity of the integrity manifest information received. If the integrity manifest information is to be updated, 520, the AIM management module updates the integrity manifest information inline, 522. The integrity manifest information is added to the ELF file.

The added integrity manifest information can also be saved out to disk, 524. When an update is made to the integrity manifest information, 520-524, or when no updates are to be made to the integrity manifest information, 520, the AIM management module can also indicate the integrity manifest information to the service processor, 526.

A flow diagram as illustrated herein provides an example of a sequence of various operations. Although shown in a particular sequence or order, unless otherwise specified. the order of the operations can be modified. Thus, the illustrated implementations should be understood only as examples, and operations can be performed in a different order, and some operations may be performed in parallel.

FIG. 6 is a flow diagram of an embodiment of a process for locating a section in a section header table. The process is a module to be performed on the host processor given an input, to produce an output. In relation to embedding integrity manifest information, the AIM management could invoke the process and receive the returned results. In an ELF file, the sections are described in the section header table. Each entry in the section-header table describes exactly one section. The description includes a name of the section, an offset of the start of the section in the ELF file, and a size of the section. In the section header, the “name” of the section is merely a reference number. The actual name of the section is stored in a separate table, referred to as the .shstrtab. The offset of the .shstrtab table can be obtained from the ELF header at the beginning of the ELF file. The reference number stored in the “name” field of the section header entry gives an offset into the .shstrtab, which will address an entry where the actual name of the section is stored.

Given a section name, 602, the module locates the section header table in the ELF file via the ELF header, which indicates the location of the section header table, 604. The module then locates the .shstrtab table in the ELF file via the field in the ELF header, 606. For each entry in the section header, the module loops through to find which entry matches the identified section name, 608.

The module determines if the string at the current entry name offset matches the section name indicated in the .shstrtab table, 610. If the current entry produces a match, 620, the module returns the index of the current entry, 622. If the current entry is not a match, 620, the module determines if the entry is the last entry, 630. If the entry is not the last entry, the module increments to the next entry, 632, and the next entry is compared to the target, 610. Note that the simple incrementing cycling through the table is one kind of search method that could be performed, and other search methods are known in the art. If the module has reached the last entry without a match, 630, the entry is not found, 634, and this is returned to the invoking entity.

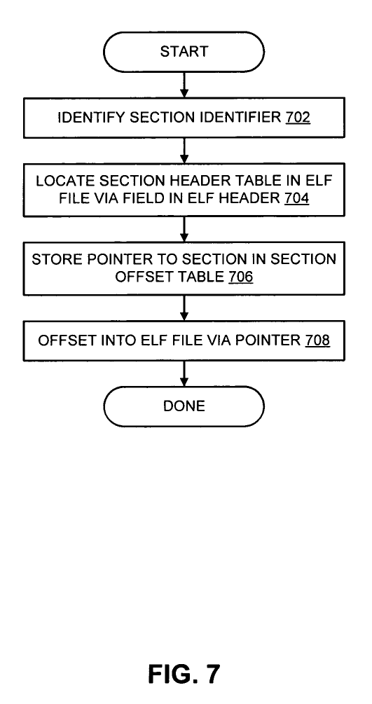

FIG. 7 is a flow diagram of an embodiment of a process for locating a section in an ELF file. The process is a module to be performed on the host processor given an input, to produce an output. In relation to embedding integrity manifest information, the AIM management could invoke the process and receive the returned results. To locate a section in the ELF file, the process indexes into the section header table of the ELF file using a section identifier, which is received as an input. The entry at the section header table includes a section start field, which provides the offset of the beginning of the section in the ELF file.

The module identifies the section by a received section identifier, 702. The module locates the section header table in the ELF file, via a field in the ELF header that indicates the location of the section header table, 704. The module stores a pointer to the section that is indicated in the section offset table, 706. With the stored pointer, the section start can be found. The pointer can be returned as a result of the module, and the AIM management, or another process module that invokes the module, can use the pointer to offset into the ELF file via the pointer to the section, 708.

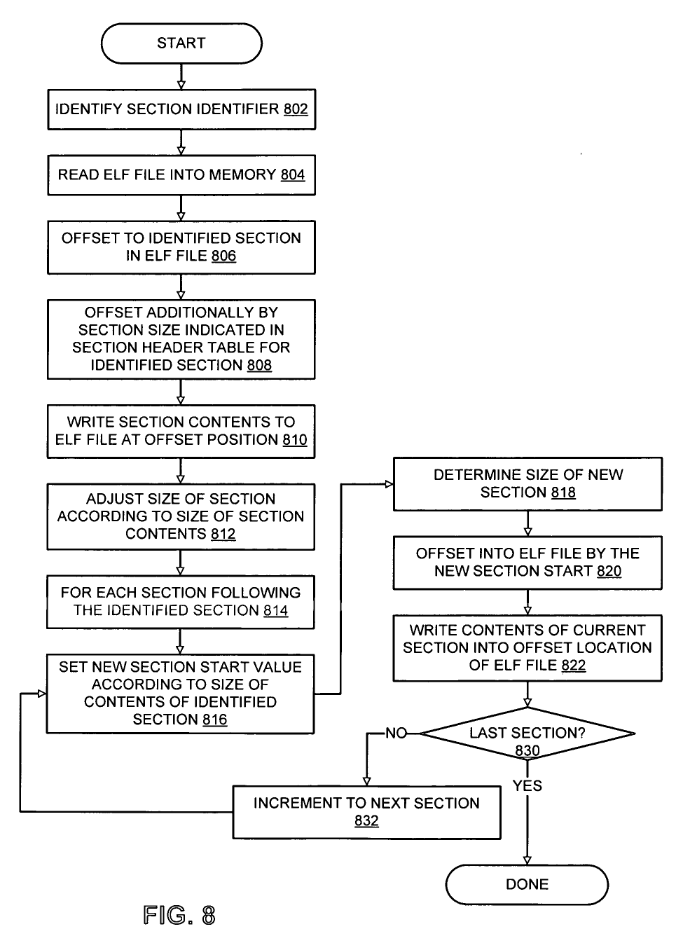

FIG. 8 is a flow diagram of an embodiment of a process for adding contents to an ELF section. The process is a module to be performed on the host processor given an input, to produce an output. In relation to embedding integrity manifest information, the AIM management could invoke the process and receive the returned results. The process module first locates the desired section (e.g., as described above). To add contents to the end of the located section, the module first allocates space at the end of the section. Allocating space for added content can be accomplished by modifying the “section size” entry in the section header entry at the index indicated by the section ID. However, increasing the allocated space for the located section could cause the section to overflow into a contiguous entity in memory, such as a following section. To prevent section overflow, the next section could be moved further down in the ELF file. Moving the next section can be accomplished by modifying the “section offset” entry in the section header corresponding to the section that is to be moved. Note that a section must be moved in a way that respects the section's alignment requirements. Thus, a moved section, in turn, could overflow into one or more sections that follow it. The moving of sections can be checked, and the moving cascaded out until overflow is prevented.

The module receives a section identifier as an input, and is thus able to identify a section, 802. The ELF file is read into memory, 804, if it is not already loaded into memory. The module offsets into the ELF file to the identified section, 806. The module can determine from the section header table a size of the section. Thus, the module offsets additionally by the section size indicated in the section header table for the identified section, 808. The additional offset respects the boundaries of the section. The module writes the section contents to the ELF file at the offset position, 810.

The new section contents may have affected the size of the section. Thus, the module adjusts the size of the section indicated in the section header table, as appropriate, according to the size of the contents of the section, 812. For each section following the identified section, the module cascades through to move the sections as needed, 814. The module identifies a section and sets the section start value to a new value according to the size of the contents of the identified section, 816. The module then determines the size of the new section, 818, and offsets into the ELF file by the new section start, 820. The module writes the contents of the current new section into the offset location of the ELF file, 822. If the module has move the last section, 830, the process is complete. If there is another section, 830, the module increments to the next section, 832, and adjusts the section start and iterates through.

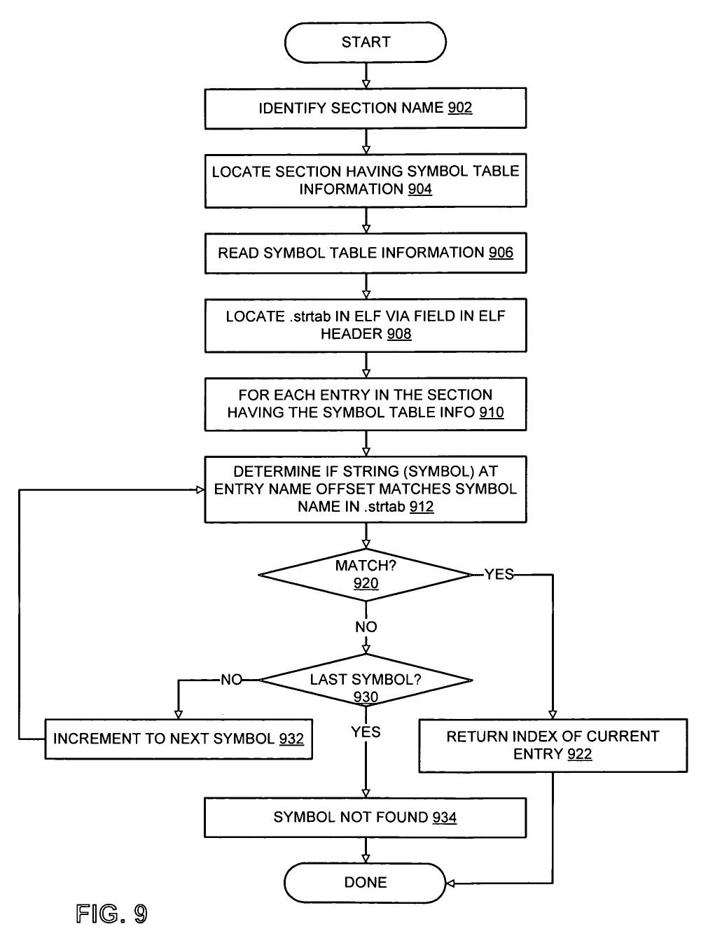

FIG. 9 is a flow diagram of an embodiment of a process for locating a symbol in a symbol table. The process is a module to be performed on the host processor given an input, to produce an output. In relation to embedding integrity manifest information, the AIM management could invoke the process and receive the returned results. In an ELF file, symbols are located in a section referred to as .symtab (symbol table), which can be located in the ELF file according to the mechanisms described above. Each entry in the symbol table describes one symbol. A symbol description includes the identifier of the section (array index in the section header table) of the section to which the symbol belongs, offset of the symbol in that section, size of the symbol, name of the symbol, etc. As before with the section name, the name of the symbol is a numeric offset of the symbol-name-string in another table, referred to as the .strtab (string table). The offset of the .strtab in the ELF file can be obtained by reading the appropriate entry from the ELF header. Thus, to locate a symbol in the symbol table (i.e., to find the symbol ID), the module locates the symbol table, and loops over all entries in the table until a match in the symbol table is found for the target symbol name.

The module identifies a section name through receiving the section name as in input, 902. The module locates the section having the symbol table information, 904, and reads the symbol table information, 906. The symbol table information indicates a value representing the symbol name. The module locates .strtab in the ELF file via a field in the ELF header, 908, and iterates through the entries in .strtab to find a match for the symbol name.

For each entry in the section having the symbol table information, 910, the module determines if the string (symbol) at the entry name offset matches the symbol name at the current entry in .strtab, 912. If the string matches, 920, the module returns the index of the current entry, 922. If the string does not match, 920, the module determines whether the last symbol has been searched, 930. If the last symbol has not been searched, the module increments to the next symbol in the table, 932, and checks the next entry. If the last symbol in the table has been searched without a match, 930, the module returns an indication that the symbol is not found, 934.

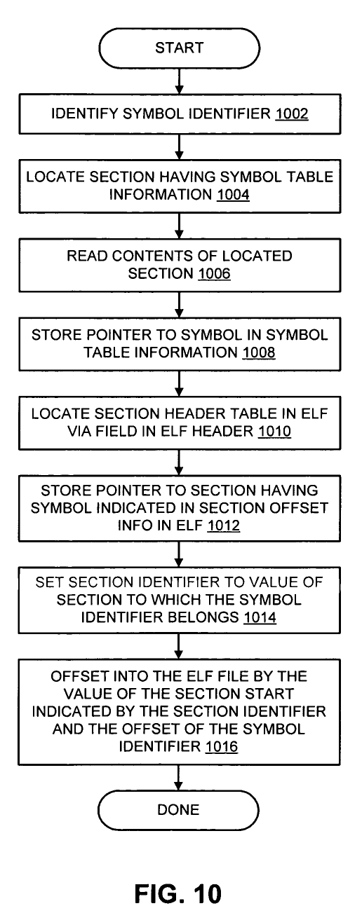

FIG. 10 is a flow diagram of an embodiment of a process for locating a symbol in an ELF file. The process is a module to be performed on the host processor given an input, to produce an output. In relation to embedding integrity manifest information, the AIM management could invoke the process and receive the returned results. The module locates the symbol table by reading the appropriate field of the ELF header. Using a symbol ID input, the module indexes into the symbol table to obtain the section ID of the section to which the symbol belongs, which is indicated at the indexed entry. The module locates the indicated section using the section ID, for example, as described above. The module further offsets into the located section with a value indicated in a symbol offset field in the symbol table entry.

The module identifies the symbol identifier as an input to the module, 1002, and locates the section having the symbol table information, 1004. The module reads the contents of the located section, which indicate a pointer to the symbol, 1006. The module stores the pointer to the symbol obtained in the symbol table information, 1008. The pointer indicates the location of the symbol.

The module locates the section header table in the ELF file via a field in the ELF header, 1010. The module stores the pointer to the section having the symbol as indicated in the section offset information in the ELF file, 1012. The module sets the section identifier to the value of the section to which the symbol belongs, as indicated in the section pointer, 1014. The module then offsets into the ELF file by the value of the section start indicated by the section identifier, and the offset of the symbol identifier to reference the symbol, 1016.

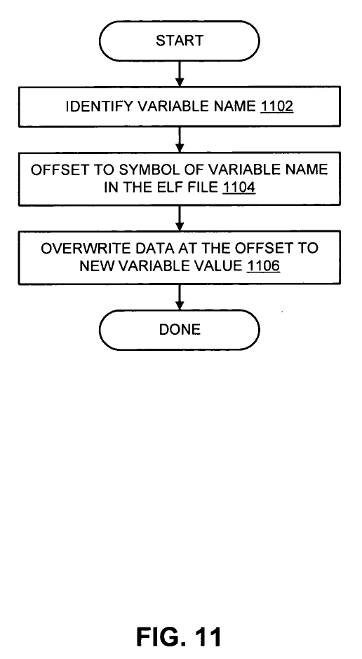

FIG. 11 is a flow diagram of an embodiment of a process for modifying the value of a variable related to integrity information. The process is a module to be performed on the host processor given an input, to produce an output. In relation to embedding integrity manifest information, the AIM management could invoke the process and receive the returned results. The variables in the original source code of the program are described with symbols in the resulting ELF file. The name of the resulting symbol is typically the same as that of the original variable. Thus, to modify the value of a variable, the module finds the symbol ID using the variable name, for example, as described above. The module then locates the symbol in the ELF file using the located symbol ID, for example, as described above. The module then can modify the symbol by overwriting the symbol location in the ELF file.

The module identifies the target variable name by receiving the variable name as an input, 1102. The module also receives or obtains new data to be written to the variable. The module offsets to the symbol of the variable name in the ELF file, 1104, and overwrites the data at the offset to the variable to the new variable value, 1106.

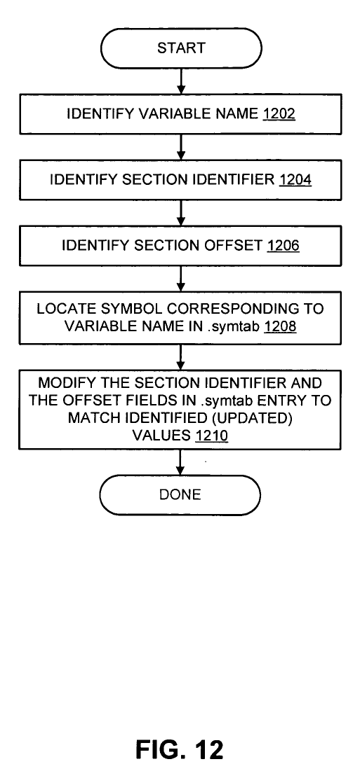

FIG. 12 is a flow diagram of an embodiment of a process for pointing a variable to an offset inside a section of an ELF file. The process is a module to be performed on the host processor given an input, to produce an output. In relation to embedding integrity manifest information, the AIM management could invoke the process and receive the returned results. The module locates the symbol table by reading the appropriate field in the ELF header. The module locates the symbol ID of the target variable, or variable of interest, for example, as described above. The module indexes into the symbol table using the located symbol ID, and modifies the section and offset information in the entry.

The module receives as inputs a variable name, section identifier, and section offset. The module identifies the variable name of the input variable name, 1202, the section identifier, 1204, and the section offset value, 1206. The module locates the symbol corresponding to the variable name in the .symtab table, 1208. The module modifies the section identifier and offset fields in the .symtab table entry to match the identified (updated) values, 1210.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method comprising:
determining integrity manifest information for a program, the integrity manifest information to include an integrity check value for zero or more sections of the program;
embedding the integrity manifest information in an object file of the program, the object file of a format that supports relocatable file sections; and
loading into volatile memory the object file of the program, including the integrity manifest information.

2. The method of claim 1, wherein embedding the integrity manifest information in the object file of the format that supports relocatable file sections comprises:
embedding the integrity manifest information in an object file compatible with the Executable and Linkable Format (ELF).

3. The method of claim 1, wherein embedding the integrity manifest information in the object file comprises:
adding the integrity manifest information in the object file in-line to be accessible to the program while the program is loaded in volatile memory.

4. The method of claim 3, further comprising:
applying fix-up information to the integrity manifest information added to the object file.

5. The method of claim 3, wherein adding the integrity manifest information in-line comprises:
adding the integrity manifest information in conjunction with applying a patch to the program.

6. The method of claim 3, further comprising:
retaining the in-line added integrity manifest information in non-volatile storage.

7. The method of claim 1, wherein embedding the integrity manifest information in the object file comprises:
embedding an integrity manifest indicator in the object file that indicates a virtual memory location and size of an integrity manifest in which the integrity manifest information is embedded.

8. The method of claim 7, wherein the integrity manifest indicator comprises separate variables for the virtual memory location and integrity manifest size.

9. The method of claim 7, wherein embedding the integrity manifest indicator in the object file comprises replacing existing integrity manifest location and size information with updated integrity manifest location and size information.

10. The method of claim 7, further comprising:
passing the integrity manifest indicator to a service processor that monitors the program, to indicate the integrity manifest of the program to the service processor.

11. The method of claim 1, wherein loading the file into volatile memory comprises:
loading an integrity manifest for the program, the determined integrity manifest information to be embedded into the integrity manifest.

12. An article of manufacture comprising a machine readable medium having content stored thereon to provide instructions to cause a machine to perform operations, including:
identifying integrity manifest information to embed in a program, the integrity manifest information to include an integrity check value for zero or more sections of the program;
adding into volatile memory a data file associated with the program, the data file of a format that supports relocatable file sections; and
embedding the integrity manifest information in-line within the data file in volatile memory.

13. The article of manufacture of claim 12, wherein the content to provide instructions for embedding the integrity manifest information in-line within the data file comprises:
adding a new integrity manifest for the program that has no integrity manifest information.

14. The article of manufacture of claim 12, wherein the data file is part of an object file, and wherein the content to provide instructions for embedding the integrity manifest information in-line within the data file comprises:
adding the integrity manifest information to an existing section of the object file.

15. The article of manufacture of claim 14, wherein the content to provide instructions for adding the integrity manifest information to the existing section of the object file further comprises:
expanding the existing section of the object file to create space to add the integrity manifest information.

16. The article of manufacture of claim 15, wherein the content to provide instructions for expanding the existing section of the object file comprises:
relocating one or more sections of the object file to a different location in the volatile memory.

17. An integrity manifest management module comprising:
an integrity manifest patch identifier to identify integrity manifest patch information associated with a program, the program in a volatile memory, and the program having an associated object file of a format that supports relocation of sections of the object file, the integrity manifest patch information to include an integrity check value that verifies the integrity of a portion of the program; and
an update module coupled to the integrity manifest patch identifier, to store the identified integrity manifest patch information in the associated object file while the program is in volatile memory.

18. The integrity manifest management module of claim 17, wherein the integrity manifest patch identifier is to further receive an integrity manifest patch from an entity external to a host device that executes the program.

19. The integrity manifest management module of claim 18, wherein the integrity manifest patch identifier receives the integrity manifest patch in response to a request by the integrity manifest patch identifier for the patch.

20. The integrity manifest management module of claim 17, wherein the update module to store the integrity manifest patch information comprises the update module to replace existing integrity manifest information with updated integrity manifest information.

21. The integrity manifest management module of claim 17, further comprising:
an indicator passing module coupled to the update module, to pass an integrity manifest indicator to a service processor, the integrity manifest indicator indicating a size and location of the integrity manifest, including information in the integrity manifest patch information.

22. The integrity manifest management module of claim 21, wherein the update module is to further add a relocation entry to a relocation table of the associated object file to enable a loader that loads the program to volatile memory to relocate the integrity manifest indicator.

23. A system comprising:
a dynamic random access memory (DRAM) having an Executable and Linkable Format (ELF) file of a program, the ELF file to include an integrity manifest for the program, the integrity manifest to include an integrity check value that verifies the integrity of a portion of the program; and
an integrity manifest management module coupled to the DRAM having:
an integrity manifest patch identifier to identify integrity manifest patch information associated with the program; and
an update module coupled to the integrity manifest patch identifier, to store the identified integrity manifest patch information in the ELF file in-line, while the ELF file is in the DRAM.

24. The system of claim 23, wherein the update module further comprises:
a variable modification module to modify an integrity manifest location variable and an integrity manifest size variable, in accordance with a new location and size of the integrity manifest after the integrity manifest patch information is stored in the ELF file.

25. The system of claim 23, wherein the integrity manifest management module further comprises:
a service processor interface module to pass an integrity manifest indicator to a service processor that monitors the DRAM and verifies the integrity of the program, the integrity manifest indicator having an indication of the location of the integrity manifest and a size of the integrity manifest;
wherein the update module is to further modify the integrity manifest indicator according to the integrity manifest patch information.
